(19) United States
(12) Patent Application Publication
(10) Pub. No.: US 2025/0247537 A1
(43) Pub. Date: Jul. 31, 2025

(54) FOR QUANTIZATION OF POINT CLOUD ATTRIBUTE TRANSFORM DOMAIN COEFFICIENTS

(71) Applicant: BYTEDANCE INC., Los Angeles, CA (US)

(72) Inventors: Bharath Vishwanath, San Diego, CA (US); Kai Zhang, San Diego, CA (US); Li Zhang, San Diego, CA (US)

(21) Appl. No.: 19/184,654

(22) Filed: Apr. 21, 2025

Related U.S. Application Data
(63) Continuation of application No. PCT/US2023/035323, filed on Oct. 17, 2023.
(60) Provisional application No. 63/417,635, filed on Oct. 19, 2022.

(51) Int. Cl. H04N 19/124; H04N 19/96

(52) U.S. Cl. CPC H04N 19/124; H04N 19/96

(57) ABSTRACT

A mechanism for processing media data is disclosed. The mechanism includes changing a quantization step size of a region-adaptive hierarchical transform (RAHT) coefficient in a point cloud video unit. A conversion is performed between the media data and a media data file based on the quantization step size.

### CROSS-REFERENCE TO RELATED APPLICATIONS

This is a continuation of International Patent Application No. PCT/US2023/035323 filed on Oct. 17, 2023, which claims the priority to and benefits of U.S. Provisional Patent Application No. 63/417,635 filed on Oct. 19, 2022. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing media data, comprising: changing a quantization step size of a region-adaptive hierarchical transform (RAHT) coefficient in a point cloud video unit; and performing a conversion between the media data and a media data file based on the quantization step size.

Optionally, in any of the preceding aspects, another implementation of the aspect provides the point cloud video unit is one of a video sequence, a frame, a cubic, and a block.

Optionally, in any of the preceding aspects, another implementation of the aspect provides the quantization step size depends on a weight of the RAHT coefficient.

Optionally, in any of the preceding aspects, another implementation of the aspect provides different quantization step sizes are used for RAHT coefficients having different weights.

Optionally, in any of the preceding aspects, another implementation of the aspect provides one or more indicators are used to indicate the different quantization step sizes.

Optionally, in any of the preceding aspects, another implementation of the aspect provides the one or more indicators are included in a bitstream.

Optionally, in any of the preceding aspects, another implementation of the aspect provides the different weights are divided into different groups, and wherein different quantization offsets are conveyed for the different groups.

Optionally, in any of the preceding aspects, another implementation of the aspect provides the different weights are divided into different groups, and wherein different quantization offsets are conveyed for a subset of the different groups.

Optionally, in any of the preceding aspects, another implementation of the aspect provides the quantization step size of the RAHT coefficient is determined based on a predefined function.

Optionally, in any of the preceding aspects, another implementation of the aspect provides the predefined function comprises Δ=K/√w, where Δ is the quantization step size, wherein K is a constant, and w is a weight of the RAHT coefficient.

Optionally, in any of the preceding aspects, another implementation of the aspect provides a value of K is included in a bitstream.

Optionally, in any of the preceding aspects, another implementation of the aspect provides K is varied based a level of the point cloud video unit, and wherein the level of the point cloud video unit is a slice or a picture.

Optionally, in any of the preceding aspects, another implementation of the aspect provides the predefined function comprises Δ=K/³w, where Δ is the quantization step size, wherein K is a constant, and w is weight of the RAHT coefficient.

Optionally, in any of the preceding aspects, another implementation of the aspect provides the predefined function is used for the different weights of the RAHT coefficients within a specific range, or is used the different weights of the RAHT coefficients having specific values.

Optionally, in any of the preceding aspects, another implementation of the aspect provides clamping the quantization step size between a minimum quantization step size and a maximum quantization step size.

Optionally, in any of the preceding aspects, another implementation of the aspect provides replacing an octree layer-based adaptive quantization with a weight-based quantization.

Optionally, in any of the preceding aspects, another implementation of the aspect provides the weight-based quantization is one of a plurality of different types of quantization, and wherein additional information may be included in a bitstream or derived by a decoder to indicate which of the plurality of different types of quantization is to be used.

Optionally, in any of the preceding aspects, another implementation of the aspect provides the quantization step size is based on both a layer of the RAHT coefficient and a weight of the RAHT coefficient.

Optionally, in any of the preceding aspects, another implementation of the aspect provides determining a quantization parameter (QP) offset based on the layer of the RAHT coefficient, and modifying the QP offset based on the weight of the RAHT coefficient.

Optionally, in any of the preceding aspects, another implementation of the aspect provides varying the quantization step size based on a function, wherein the function includes both the layer of the RAHT coefficient and the weight of the RAHT coefficient.

Optionally, in any of the preceding aspects, another implementation of the aspect provides applying different quantization methods to different attribute channels.

Optionally, in any of the preceding aspects, another implementation of the aspect provides a layer-based adaptive quantization is applied to a luma channel, and wherein a quantization dependent of a weight of the RAHT coefficient is applied to a chroma channel.

Optionally, in any of the preceding aspects, another implementation of the aspect provides different functions based on a weight of the RAHT coefficient are applied to the different attribute channels.

Optionally, in any of the preceding aspects, another implementation of the aspect provides dividing the different attribute channels into different sub-groups for the different attribute channels, wherein offsets corresponding to the different sub-groups are different for the different attribute channels.

Optionally, in any of the preceding aspects, another implementation of the aspect provides partitioning the point cloud video unit into different regions and applying different quantization methods to the different regions.

Optionally, in any of the preceding aspects, another implementation of the aspect provides varying the quantization step size of the RAHT coefficient based on a function, wherein the function is based on each of a region, a layer, and a weight of the RAHT coefficient.

Optionally, in any of the preceding aspects, another implementation of the aspect provides applying layer-based quantization to some regions of the point cloud video unit and applying weight-based quantization to other regions of the point cloud video unit.

Optionally, in any of the preceding aspects, another implementation of the aspect provides determining a region-based quantization parameter (QP) offset, and modifying the region-based QP offset based on the weight of the RAHT coefficient.

Optionally, in any of the preceding aspects, another implementation of the aspect provides dividing the different regions into different sub-groups for the different regions, wherein offsets corresponding to the different sub-groups are different for the different regions.

Optionally, in any of the preceding aspects, another implementation of the aspect provides selectively enabling and disabling the method for a group of voxels.

Optionally, in any of the preceding aspects, another implementation of the aspect provides the group of voxels is a group of 2×2×2 voxels.

Optionally, in any of the preceding aspects, another implementation of the aspect provides applying different quantizations to different transform coefficients after a 2×2×2 transformed residual block has been predicted by upsampling.

Optionally, in any of the preceding aspects, another implementation of the aspect provides deriving the quantization step size using a 2×2×2 quantization parameter (QP) offset matrix.

Optionally, in any of the preceding aspects, another implementation of the aspect provides the 2×2×2 QP offset matrix is specified at a sequence level, a slice level, or a tile level of a bitstream.

Optionally, in any of the preceding aspects, another implementation of the aspect provides the 2×2×2 QP offset matrix is based on an octree.

Optionally, in any of the preceding aspects, another implementation of the aspect provides restricting use of the 2×2×2 QP offset matrix to less than all layers in the octree.

Optionally, in any of the preceding aspects, another implementation of the aspect provides using different three dimensional (3D) quantization parameter (QP) matrices for different layers in the octree.

Optionally, in any of the preceding aspects, another implementation of the aspect provides the 2×2×2 QP offset matrix is based on a weight of the RAHT coefficient.

Optionally, in any of the preceding aspects, another implementation of the aspect provides restricting use of the 2×2×2 QP offset matrix to less than all sub-bands of the RAHT coefficient, wherein each of the sub-bands represent a group of coefficients having a same weight of the RAHT coefficient.

Optionally, in any of the preceding aspects, another implementation of the aspect provides using different three dimensional (3D) quantization parameter (QP) matrices for different sub-bands of the RAHT coefficient.

Optionally, in any of the preceding aspects, another implementation of the aspect provides the 2×2×2 QP offset matrix is based on an attribute channel.

Optionally, in any of the preceding aspects, another implementation of the aspect provides using the 2×2×2 QP offset matrix for a subset of the different attribute channels.

Optionally, in any of the preceding aspects, another implementation of the aspect provides using the 2×2×2 QP offset matrix for the different attribute channels.

Optionally, in any of the preceding aspects, another implementation of the aspect provides the 2×2×2 QP offset matrix is based on different regions.

Optionally, in any of the preceding aspects, another implementation of the aspect provides using the 2×2×2 QP offset matrix for a subset of the different regions.

Optionally, in any of the preceding aspects, another implementation of the aspect provides using the 2×2×2 QP offset matrix for the different regions.

Optionally, in any of the preceding aspects, another implementation of the aspect provides modifying quantization for a subset of 2×2×2 transform coefficients instead of all of the 2×2×2 transform coefficients, wherein the 2×2×2 transform coefficients comprise eight transform coefficients.

Optionally, in any of the preceding aspects, another implementation of the aspect provides applying a coarser quantization to high frequency coefficients without modifying low frequency coefficients.

Optionally, in any of the preceding aspects, another implementation of the aspect provides the modifying quantization for a subset of 2×2×2 transform coefficients is based on one or more of an attribute channel, a weight of the RAHT coefficient, and a layer of an octree.

Optionally, in any of the preceding aspects, another implementation of the aspect provides dividing RAHT coefficients into different sub-groups and applying different quantization parameter (QP) offsets to the different sub-groups.

Optionally, in any of the preceding aspects, another implementation of the aspect provides the different sub-groups are based on a frequency of the RAHT coefficients.

Optionally, in any of the preceding aspects, another implementation of the aspect provides providing an option of using a full 2×2×2 QP offset matrix, a partial 2×2×2 QP offset matrix, or sub-group based offsets, and wherein the option is based on one or more of a layer of an octree and an attribute channel.

Optionally, in any of the preceding aspects, another implementation of the aspect provides using a function or a set of functions to relate a quantization parameter (QP) offset to a function of one or more of a layer of an octree and a transform coefficient matrix.

Optionally, in any of the preceding aspects, another implementation of the aspect provides the function or the set of functions is indicated to a decoder.

Optionally, in any of the preceding aspects, another implementation of the aspect provides the function or the set of functions is different for different attribute channels.

Optionally, in any of the preceding aspects, another implementation of the aspect provides the function or the set of functions is predetermined.

Optionally, in any of the preceding aspects, another implementation of the aspect provides a quantization parameter (QP) offset depends on one or more of an original point cloud resolution or a display resolution at a user end.

Optionally, in any of the preceding aspects, another implementation of the aspect provides a quantization for a larger display size is finer than a quantization for a smaller display size.

Optionally, in any of the preceding aspects, another implementation of the aspect provides a quantization parameter (QP) offset for chroma is based on a chroma sub-sampling employed.

Optionally, in any of the preceding aspects, another implementation of the aspect provides quantization for 4:4:4 content is coarser than quantization for 4:4:4 content.

Optionally, in any of the preceding aspects, another implementation of the aspect provides applying previously-disclosed offsets to only alternating current (AC) coefficients when direct current (DC) coefficients have been inherited from a previous layer of an octree.

Optionally, in any of the preceding aspects, another implementation of the aspect provides conveying previously-disclosed offsets to a decoder, wherein the previously-disclosed offsets are applied to only alternating current (AC) coefficients when direct current (DC) coefficients have been inherited from a previous layer of an octree.

Optionally, in any of the preceding aspects, another implementation of the aspect provides one or more syntax elements are included in a bitstream to indicate usage of any of the methods.

Optionally, in any of the preceding aspects, another implementation of the aspect provides the one or more syntax elements comprise a flag.

Optionally, in any of the preceding aspects, another implementation of the aspect provides the one or more syntax elements are included in a syntax structure of a parameter set in the bitstream.

Optionally, in any of the preceding aspects, another implementation of the aspect provides the one or more syntax elements are included in a sequence parameter set (SPS) in the bitstream.

Optionally, in any of the preceding aspects, another implementation of the aspect provides the one or more syntax elements are included in a grouping parameter set (GPS) in the bitstream.

Optionally, in any of the preceding aspects, another implementation of the aspect provides the one or more syntax elements are included in an adaptation parameter set (APS) in the bitstream.

Optionally, in any of the preceding aspects, another implementation of the aspect provides the one or more syntax elements are included a portion of the bitstream corresponding to one tile.

Optionally, in any of the preceding aspects, another implementation of the aspect provides the one or more syntax elements are included a portion of the bitstream corresponding to one slice.

Optionally, in any of the preceding aspects, another implementation of the aspect provides the one slice comprises an attribute slice or a geometry slice.

Optionally, in any of the preceding aspects, another implementation of the aspect provides the one or more syntax elements are included in a slice header.

Optionally, in any of the preceding aspects, another implementation of the aspect provides a slice in the slice header comprises an attribute slice or a geometry slice.

Optionally, in any of the preceding aspects, another implementation of the aspect provides one or more flags for quantization using the RAHT coefficient as weighted are included in a bitstream, the one or more flags comprising:
a flag to indicate QP offsets for different sub-bands, where the QP offsets are binarized with fixed-length coding, exponential-Golomb coding, or truncated unary coding;
a flag to indicate that QP offsets are progressively coded, wherein progressively coded is defined as a difference between a QP offset of a current sub-band and a QP offset of a previous sub-band;
a flag to indicate whether a quantization method is enabled or disabled for different sub-bands;
a flag to indicate whether adaptive quantization is enable or disabled, wherein the flag is set based on one or more of an attribute channel, a layer, a region of the point cloud video unit, a tile, or a group of voxels;
a flag to indicate a function for different frames, sequences, slices tiles, attribute channels, or regions of the point cloud video unit, wherein a list or table of different functions based on a weight of the RAHT coefficient is provided; and
a flag to indicate different function parameters for different frames, sequences, slices tiles, attribute channels, or regions of the point cloud video unit,
wherein the one or more flags are context coded or bypass coded.

Optionally, in any of the preceding aspects, another implementation of the aspect provides one or more flags related to using different quantization for different transform coefficients in a 2×2×2 transformed residual block after up-sampled prediction are included in a bitstream, the one or more flags comprising:
a flag to indicate a 2×2×2 QP matrix or a matrix of QP offsets for different RAHT coefficients corresponding to the 2×2×2 transformed residual block, wherein entries of the 2×2×2 QP matrix or the matrix of QP offsets are binarized with fixed-length coding, exponential-Golomb coding, or truncated unary coding;
a flag to indicate that QP offsets are progressively coded, wherein progressively coded is defined as a difference between a QP offset of a current RAHT coefficient and a previous RAHT coefficient;
a flag to indicate a partial 2×2×2 matrix instead of a full 2×2×2 matrix;
a flag to indicate a QP offset for each sub-group;
a flag to indicate that QP offsets are progressively coded with respect to a layer of an octree, wherein
progressively coded with respect to the octree is defined as a difference between a QP offset of a current layer and a previous layer;
a flag to indicate that QP offsets are progressively coded with respect to attribute channels, wherein progressively coded with respect to the attribute channels is defined as a difference between a QP offset of a current attribute channel and a previous attribute channel;
a flag to indicate usage of a partial matrix or a full matrix, wherein the flag is based on one or more of a layer of an octree, a region of the point cloud video unit, and wherein the flag is included in a level of a bitstream corresponding to a sequence, a slice, a tile, or a region of the point cloud video unit;
a flag to indicate a subset of 2×2×2 coefficients for which a QP offset is applied; and
a flag to indicate a function that determines a relationship between a QP offset and a layer of an octree or a transform coefficient matrix;
wherein the one or more flags are context coded or bypass coded,
wherein the QP offsets are only signaled for AC coefficients when DC coefficients are inherited from a previous level of the octree, and
wherein the one or more flags are set to a value to enable or disable use of the QP offsets for different layers of the octree, attribute channels, or sub-bands.

Optionally, in any of the preceding aspects, another implementation of the aspect provides the designation 2×2×2 is replaced by M×N×K, wherein M, N, and K are each integers.

Optionally, in any of the preceding aspects, another implementation of the aspect provides one or more of the QP matrix and the QP offset are included in different levels in the bitstream.

Optionally, in any of the preceding aspects, another implementation of the aspect provides one or more of a first QP matrix is included in a first level of the bitstream and a first QP offset is included in a second level of the bitstream, wherein the first level is higher than the second level.

Optionally, in any of the preceding aspects, another implementation of the aspect provides one or more of the second QP matrix and the second QP offset are predicted based on the first QP matrix and the first QP offset for the point cloud video unit in the second level.

Optionally, in any of the preceding aspects, another implementation of the aspect provides one or more of the first QP matrix and the first QP offset are overwritten by the second QP matrix and the second QP offset for the point cloud video unit in the second level.

Optionally, in any of the preceding aspects, another implementation of the aspect provides one or more of the first QP matrix and the first QP offset are used together with the second QP matrix and the second QP offset to derive a final QP matrix and a final QP offset for the point cloud video unit in the second level.

Optionally, in any of the preceding aspects, another implementation of the aspect provides the first QP matrix and the first QP offset are added to the second QP matrix and the second QP offset.

Optionally, in any of the preceding aspects, another implementation of the aspect provides a syntax element in any of the preceding methods is binarized as a flag, a fixed length code, an exponential-Golomb (EG) code, a unary code, a truncated unary code, or a truncated binary code, and wherein the syntax element is signed or unsigned.

Optionally, in any of the preceding aspects, another implementation of the aspect provides a syntax element in any of the preceding methods is coded with at least one context model or is bypass coded.

Optionally, in any of the preceding aspects, another implementation of the aspect provides a syntax element in any of the preceding methods is included in the bitstream in a conditional way, or signaled only when a function corresponding to the syntax element is applicable.

Optionally, in any of the preceding aspects, another implementation of the aspect provides a syntax element in any of the preceding methods is included in the bitstream at a block level, an octree level, a sequence level, a group of pictures level, a picture level, a slice level, a region of the point cloud video unit level, or in a coding structure of a coding unit (CU), a coding structure of a prediction unit (PU), a sequence header, a picture header, a sequence parameter set (SPS), a picture parameter set (PPS), an adaptation parameter set (APS), or a slice header.

Optionally, in any of the preceding aspects, another implementation of the aspect provides whether or how to apply any of the preceding methods is included in the bitstream at a block level, an octree level, a sequence level, a group of pictures level, a picture level, a slice level, a region of the point cloud video unit level, or in a coding structure of a coding unit (CU), a coding structure of a prediction unit (PU), a sequence header, a picture header, a sequence parameter set (SPS), a picture parameter set (PPS), an adaptation parameter set (APS), or a slice header.

Optionally, in any of the preceding aspects, another implementation of the aspect provides the conversion includes encoding the media data into a bitstream.

Optionally, in any of the preceding aspects, another implementation of the aspect provides the conversion includes decoding the media data from a bitstream.

A second aspect relates to apparatus for processing media data comprising: a processor; and a non-transitory memory with instructions thereon, wherein the instructions upon execution by the processor, cause the processor to perform the method in any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises the method of any of the preceding aspects.

A fifth aspect relates to method for storing a bitstream of a video comprising the method of any of the preceding aspects.

A sixth aspect relates to a method, apparatus or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an example of parent-level nodes for each sub-node of transform unit node.

FIG. 2 is an example operation of Delta Layer QP for RAHT.

FIG. 3 is an example modified bitstream structure to support layer delta QP.

FIG. 4 is a block diagram showing an example video processing system.

FIG. 5 is a block diagram of an example video processing apparatus.

FIG. 6 is a flowchart for an example method of video processing.

FIG. 7 is a block diagram that illustrates an example video coding system.

FIG. 8 is a block diagram that illustrates an example encoder.

FIG. 9 is a block diagram that illustrates an example decoder.

FIG. 10 is a schematic diagram of an example encoder.

FIG. 11 is an image or video method implemented by a coding device according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. INITIAL DISCUSSION

This disclosure is related to media file format. Specifically, this disclosure is related to point cloud coding technologies. Specifically, it is related to quantization of points in region-adaptive hierarchical transform. The ideas may be applied individually or in various combination, to any point cloud coding standard or non-standard point cloud codec, e.g., the being-developed Geometry based Point Cloud Compression (G-PCC).

### 2. ABBREVIATIONS

G-PCC Geometry based Point Cloud Compression
MPEG Moving Picture Experts Group
3DG Three-dimensional (3D) Graphics Coding Group
CFP Call For Proposal
V-PCC Video-based Point Cloud Compression
RAHT Region-Adaptive Hierarchical Transform
SPS Sequence Parameter Set
APS Attribute Parameter Set
GPS Geometry Parameter Set

### 3. FURTHER DISCUSSION

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard [1]. The final standard will consist in two classes of solutions. Video-based Point Cloud Compression (V-PCC) is appropriate for point sets with a relatively uniform distribution of points [2]. Geometry-based Point Cloud Compression (G-PCC) is appropriate for more sparse distributions [3]. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Octree Geometry Compression

Point cloud codec can process the various information in different ways. Usually there are many optional tools in the codec to support the coding and decoding of geometry information and attribute information respectively. Among geometry coding tools in G-PCC, octree geometry compression has an important influence for point cloud geometry coding performance [4].

In G-PCC, one of important point cloud geometry coding tools is octree geometry compression, which leverages point cloud geometry spatial correlation. If geometry coding tools is enabled, a cubical axis-aligned bounding box, associated with octree root node, will be determined according to point cloud geometry information. Then the bounding box will be subdivided into 8 sub-cubes, which are associated with 8 sub-nodes of root node (a cube is equivalent to node hereafter). An 8-bit code is then generated by specific order to indicate whether the 8 sub-nodes contain points separately, where one bit is associated with one sub-node. The bit associated with one sub-node is named occupancy bit and the 8-bit code generated is named occupancy code. The generated occupancy code will be signaled according to the occupancy information of neighbor node. Then only the nodes which contain points will be subdivided into 8 sub-nodes furtherly. The process will perform recursively until the node size is 1. So, the point cloud geometry information is converted into occupancy code sequences.

In decoder side, occupancy code sequences will be decoded and the point cloud geometry information can be reconstructed according to the occupancy code sequences.

A breadth-first scanning order will be used for the octree. In one level of the octree, the octree node will be scanned in a Morton order. If the coordinate of one node is represented by N bits, the coordinate (X, Y, Z) of the node can be represented as follows.

$$X = ( {x}_{N - 1} {x}_{N - 2} … {x}_{1} {x}_{0} )$$

$$Y = ( {y}_{N - 1} {y}_{N - 2} … {y}_{1} {y}_{0} )$$

$$Z = ( {z}_{N - 1} {z}_{N - 2} … {z}_{1} {z}_{0} )$$

Its Morton code can be represented as follows.

$$M = ( {x}_{N - 1} {y}_{N - 1} {z}_{N - 1} {x}_{N - 2} {y}_{N - 2} {z}_{N - 2} … {x}_{1} {y}_{1} {z}_{1} {x}_{0} {y}_{0} {z}_{0} )$$

The Morton order is the order from small to large according to Morton code.

### 3.2 Region-Adaptive Hierarchical Transform (RAHT)

In G-PCC, one of important point cloud attribute coding tools is RAHT. It is a transform that uses the attributes associated with a node in a lower level of the octree to predict the attributes of the nodes in the next level [5]. It assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level l be g_{l,x,y,z}, for x, y, z integers. g_{l,x,y,z} was obtained by grouping g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{l,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, say g_{l,2x,y,z} and g_{l,2x+1,y,z}, with their respective weights, ω_{l,2x,y,z} and ω_{l2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

Where ω₁=ω_{l,2x,y,z} and ω₂=ω_{l,2x+1,y,z} and

$${T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , z} + {ω}_{l , 2 x + 1 , y , z}$$

In the last stage, the tree root, the remaining two voxels g_{1,0,0,0} and g_{1,1,0,0} are transformed into the final two coefficients as:

$$[ \begin{matrix}{g}_{DC} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ]$$

Where g_{DC}=g_{0,0,0,0.}

### 3.3 Upsampled Transform Domain Prediction in RAHT

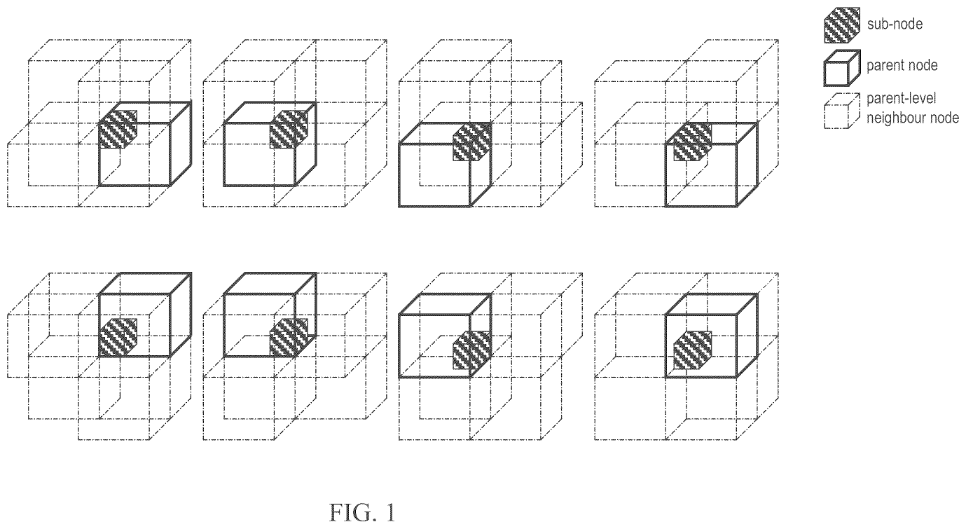

FIG. 1 is an example of parent-level nodes for each sub-node of transform unit node.

The transform domain prediction is introduced to improve coding efficiency on RAHT [6]. It is formed of two parts.

First, the RAHT tree traversal is changed to be descent based from the previous ascent approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Second, for each sub-node of transform unit, a corresponding predicted sub-node is produced by upsampling the previous transform level. Actually, only sub-node that contains at last one point will produce a corresponding predicted sub-node. The transform unit that contains 2×2×2 predicted sub-nodes is transformed and subtracted from the transformed attributes at the encoder side. The residual of AC coefficients will be signalled. Note that the prediction does not affect the DC coefficient.

Each sub-node of transform unit node is predicted by 7 parent-level nodes where 3 coline parent-level neighbor nodes, 3 coplane parent-level neighbor nodes and 1 parent node. Coplane and coline neighbors are the neighbors that share a face and an edge with current transform unit node, respectively. FIG. 1 shows 7 parent-level nodes for each sub-node of transform unit node.

The attribute aᵤₚ of each sub-node is predicted depending on the distance between it and its parent-level node as follows.

$${α}_{up} = \sum {ω}_{k} {α}_{k} / \sum {ω}_{k}$$

αₖ is the attribute of its one parent-level node and wk is weight depending on the distance. In G-PCC, ωₚₐᵣₑₙₜ: ω_{coplane}: ω_{coline}=4:2: 1.

### 3.4 Quantization

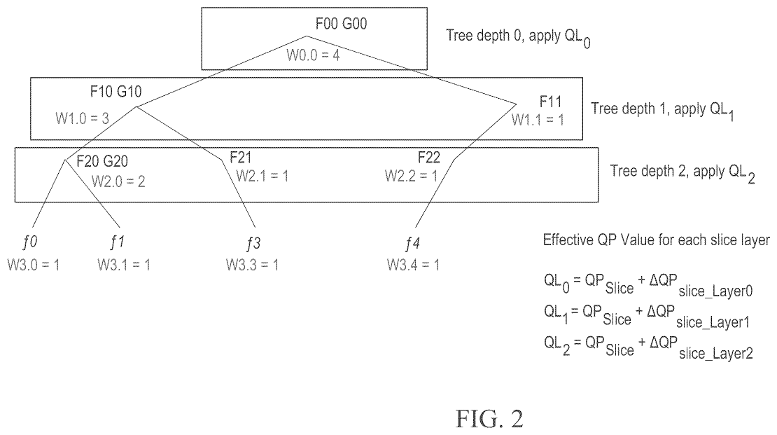

FIG. 2 is an example operation of Delta Layer QP for RAHT. FIG. 2 shows RAHT with delta QP for each layer and specific delta QP is applied on each layer. The effective QP value for each layer in a particular slice is added between delta QP of that layer with QP for that slice. The final residue value will be the square root of the attribute divided by weight and effective QP value.

The quantization parameter (QPAPS) are stored in the Attribute Parameter Set (APS), and the parameters can be changed slice-by-slice and further layer by layer.

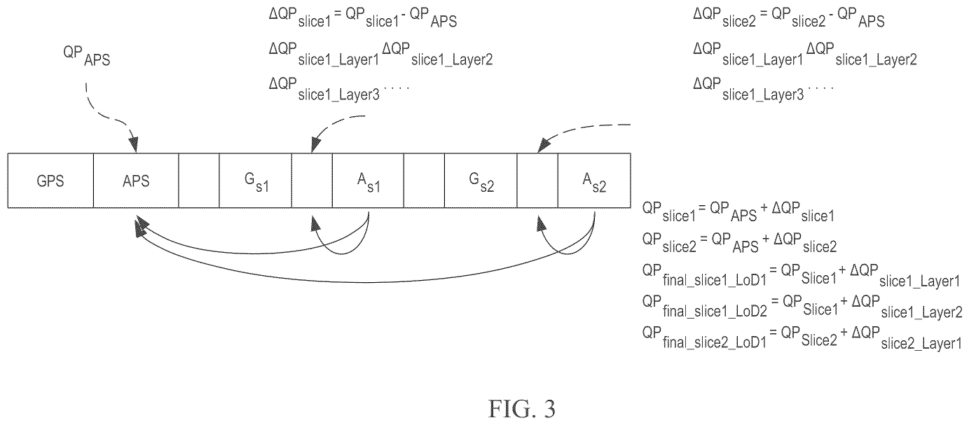

FIG. 3 is an example modified bitstream structure to support layer delta QP.

By adding the delta QP layer value (ΔQP_{slice1_Layer1}, ΔQP_{slice1_Layer2}. . . ) in each attribute slice header, the QP value can be changed for each layer of a particular. Delta QP layer value is the difference between QPslice and effective QP value of that slice's layer. Delta QP layer is present only if layer_QP present_flag in attribute slice header ASH is set to 1.

### 3.5 Coding Parameter Classification

There are some coding parameters in the encoder to control the encoding of point cloud. Some of them are signaled to the decoder to support the decoding process. The parameters can be classified and stored in several clusters according to the affected part of each parameter, such as geometry parameter set (GPS), attribute parameter set (APS) and sequence parameter set (SPS). The parameters that control the geometry coding tools are stored in GPS. The parameters that control the attribute coding tools are stored in APS. For example, the parameters that describe the attribute category of point cloud sequence and the data accuracy of coding process are stored in SPS.

### 4. TECHNICAL PROBLEMS ADDRESSED BY DISCLOSED EMBODIMENTS

An example design for point cloud attribute quantization of region-adaptive hierarchical transform (RAHT) coefficients have the following problems:

First, the quantization step size can be varied for different layers. However, this may not be always optimal. Weight of a RAHT coefficient may be a better parameter for deriving or deciding the quantization step size.

Second, after up-sampled prediction, the 2×2×2 residue block is transformed and quantized. However, during quantization, all the eight transform coefficients are quantized in the same way, which may not be optimal.

### 5. A LISTING OF SOLUTIONS AND EMBODIMENTS

To address at least some of the above problems and some other problems not mentioned, methods as summarized below are disclosed. The items should be considered as examples to explain the general concepts and should not be interpreted in a narrow way. Furthermore, these inventions can be applied individually or combined in any manner.
1) In one example, the quantization step size used in RAHT coefficient may change in a point cloud video unit, which may be a sequence, a frame, a cubic, a block, etc.
   a. In one example, the quantization step size may depend on the weight of the RAHT coefficient.
   b. In one example, different step sizes may be used for coefficients of different weights.
      i. In one example, there may be at least one indication to indicate the different step sizes, such as QP offsets.
      ii. In one example, the indication may be explicitly signalled to the decoder.
      iii. In one example, the weights may be divided into different groups and different quantization offsets may be conveyed for different groups.
      iv. In one example, the weights may be divided into different groups and different quantization offsets may be conveyed for a subset of the groups.
   c. In one example, the determination of step size may be based on some pre-defined function.
      i. In one example, the function may be,

$$Δ = \frac{K}{\sqrt{w}} ,$$

where Δ is the quantization step size, K is a constant and w is the weight of the RAHT coefficient.
   1. In one example, the value of K may be signalled to the decoder and may be varied for example at the slice level, picture level etc.
   2. In one example, the function \sqrt{w} may be replaced by other functions such as w, ³\sqrt{w} etc.
   3. In one example, the function may be used for only specific ranges or values of w.
   ii. In one example, the step size may be clamped between minimum and maximum step size values.
   d. In one example, the weight-based quantization may completely replace the octree layer based adaptive quantization.
   e. In one example, the weight-based quantization may be an additional mode of quantization and an additional information may be conveyed to the decoder about the usage of the type of quantization.
   f. In one example, the quantization may be determined based on both the layer and weight of the RAHT coefficient.
      i. In one example, the QP offset may be first determined based on the layer and the offset may be further modified based on the weight of the RAHT coefficient.
      ii. In one example, the quantization step size may vary based on a function that is jointly determined by layer and weight of RAHT coefficient.
   g. In one example, different quantization methods may be applied for different attribute channels.
      i. In one example, the quantization for luma channel may be based on the layer based adaptive quantization and the quantization for chroma channel may be based on the quantization dependent on the weight of the RAHT coefficient.
      ii. In one example, different functions based on RAHT weight may be employed for different attribute channels.
      iii. In one example, for different channels, the division into different sub-groups may be different and the corresponding offsets may also be different.
   h. In one example, the point cloud may be partitioned into regions and different quantization methods may be applied for different regions.
      i. In one example, the quantization step size may vary based on a function that is jointly determined by region, layer and weight of RAHT coefficient.
      ii. In one example, the layer-based quantization may be employed for some regions and the weight-based quantization may be used for others.
      iii. In one example, a region based QP offset may be first determined and then the QP offset may be further modified based on the weight.
      iv. In one example, for different regions, the division into different sub-groups may be different and the corresponding offsets signalled may also be different.
   i. In one example, the method may be selectively enabled/disabled for a group of voxels such as for example a group of 2×2×2 voxels.
2) In one example, for the 2×2×2 transformed residue block after up-sampled prediction, different quantization may be used for different transform coefficients.
   a. In one example, a 2×2×2 QP offset matrix may be used to derive the quantization step size.
      i. In one example, this matrix may be specified at sequence level/slice level/tile level etc.
   b. In one example, the 2×2×2 QP offset matrix may depend on the octree layer.
      i. In one example, usage of this matrix may be restricted to certain layers in octree.
      ii. In one example, different 3D QP matrices may be used for different layers in octree.
   c. In one example, the 2×2×2 QP offset matrix may depend on the RAHT weight.
      i. In one example, usage of this matrix may be restricted to some sub-bands of RAHT, where sub-band represents a group of coefficients that have same RAHT weight.
      ii. In one example, different 3D QP matrices may be used for different sub-bands.
   d. In one example, the 2×2×2 QP offset matrix may depend on the attribute channel.
      i. In one example, the matrix may be used for only a subset of attribute channels.
      ii. In one example, different matrices may be used for different attribute channels.
   e. In one example, 2×2×2 QP matrix may depend on the regions.
      i. In one example, the QP matrix may be used only for some regions.
      ii. In one example, different matrices may be used for different regions.
   f. In one example, instead of modifying quantization for all 8 (2×2×2 ) transform coefficients, only a subset of coefficients may be modified.
      i. For example, a coarser quantization may be applied for high frequency coefficients without modifying the low frequency coefficients.
      ii. For example, the usage of this partial modification of coefficients may depend on other factors like attribute channel, RAHT weight, octree layer etc.
   g. In one example, the RAHT coefficients may be divided into subgroups and different QP offsets could be applied for different subgroups.
      i. For example, the sub-groups may be based on frequency of the coefficient.
   h. In one example, there may be additional option regarding the usage of a full 2×2×2 QP offset matrix or a partial matrix or subgroup-based offsets, which may depend on various parameters like octree layer, attribute channel etc.
   i. In one example, a function or a set of functions may be used to relate the QP offset as a function of octree layer, transform coefficient index etc.
      i. In one example, the function or functions may be conveyed to the decoder.
      ii. In one example, the function or functions could be different for different attribute channels.
      iii. In one example, only predetermined functions may be used.
   j. In one example, the QP offset may depend on the factors like original point cloud resolution, display resolution at the user end etc.
      i. In one example, larger display size may require finer quantization than smaller displays.
   k. In one example, the QP offset for chroma may depend on the chroma sub-sampling employed.
      i. For example, coarser quantization could be applied for 4:4:4 content as compared to 4:2:0 content.
   l. In one example, the method may be selectively enabled/disabled for a group of voxels, such as a group of 2×2×2 voxels.
   m. In one example, when DC is inherited from pervious octree layer, the previously disclosed offsets may be conveyed or applied only for the AC coefficients.
3) In one example, for each of the above disclosed methods, a syntax element (e.g., a flag) or syntax elements (flags) may be signaled in the bitstream to specify the usage of disclosed method(s).
   a. In one example, the bitstream unit may be the bitstream of the syntax structure of parameter set.
      i. In one example, the syntax structure may be SPS.
      ii. In one example, the syntax structure may be GPS.
      iii. In one example, the syntax structure may be APS.
   b. In one example, the bitstream unit may be the bitstream of one tile.
   c. In one example, the bitstream unit may be the bitstream of one slice.
      i. In one example, the slice may be attribute slice, geometry slice.
   d. In one example, the bitstream unit may be slice header.
      i. In one example, the slice may be attribute slice, geometry slice.
   e. In one example, for RAHT coefficient quantization based on RAHT coefficient weight, following flags may be signalled.
      i. In one example, QP offsets may be signalled for different sub-bands. The offset may be binarized with fixed-length coding, EG coding, (truncated) unary coding, etc.
      ii. Furthermore, the QP offset maybe progressively coded, i.e., the difference between QP offset of current sub-band and previous sub-band may be signalled.
      iii. In one example, additional flags may be signalled to enable/disable the quantization method for different sub-bands.
      iv. In one example, flags may be signalled based on the attribute channels, layer, regions, tile, a group of voxels etc. to enable/disable the adaptive quantization.
      v. In one example, a list/table of different functions based on RAHT weight may be defined and flags may be signalled to specify the function for different frames, sequences, slices, tiles, attribute channels, regions etc.
      vi. Furthermore, different function parameters may be signalled for different frames, sequences, slices, tiles, attribute channels, regions etc.
      vii. In on example, the above flags could be context coded or bypass coded.
   f. In one example, for method to use different quantization for different transform coefficients in the 2×2×2 transformed residue block after up-sampled prediction, following flags maybe signalled.
      i. In one example, a (2×2×2 ) QP matrix or a matrix of QP offsets may be signalled for different RAHT coefficients (corresponding to the transform of the 2×2×residue block). The entries of the matrix may be binarized with fixed-length coding, EG coding, (truncated) unary coding, etc.
      ii. Furthermore, the QP offsets maybe progressively coded, i.e., the difference between QP offset of current RAHT coefficient and previous RAHT coefficient may be signalled.
      iii. In one example, instead of a full 2×2×2 matrix, a partial matrix may be signalled.
      iv. In one example, QP offset may be signalled for each sub-group.
      v. In one example, the QP offsets may be progressively coded with respect to octree layer, i.e., the difference between the QP offset of the current layer and the previous layer may be signalled.
      vi. In one example, the QP offsets may be progressively coded with respect to the attribute channels, i.e., the difference between the QP offset of the current attribute channel and a previously coded channel may be coded.
      vii. In one example, additional flags, may be signalled to specify the usage of full matrix or the partial matrix and the flag may depend on octree layer, regions etc. and could be signalled at, for example, sequence/frame/slice/tile/region level etc.
      viii. Furthermore, flags may be signalled to signal the subset of 2×2×2 coefficients for which QP offset is applied.
      ix. In one example, flags may be signalled to convey the function that determines the relationship between QP offset and octree layer, transform coefficient index, etc.
      x. In one example, the above flags could be context coded or bypass coded.
      xi. In one example, when DC is inherited from previous octree level, the QP offsets are only signaled for the AC coefficients.
      xii. In one example, flags may be signaled to enable/disable the usage of the QP offsets for different octree layers, attribute channels, sub-bands etc.
4) A syntax element disclosed above may be binarized as a flag, a fixed length code, an EG (x) code, a unary code, a truncated unary code, a truncated binary code, etc. It can be signed or unsigned.
5) A syntax element disclosed above may be coded with at least one context model. Or it may be bypass coded.
6) A syntax element disclosed above may be signaled in a conditional way.
   a. The SE is signaled only if the corresponding function is applicable.
7) A syntax element disclosed above may be signaled at block level/octree level/sequence level/group of pictures level/picture level/slice level/region level, such as in coding structures of CU/PU, or sequence header/picture header/SPS/APS/PPS/slice header.
8) Whether to and/or how to apply the disclosed methods above may be signalled at block level/octree level/sequence level/group of pictures level/picture level/slice level/region level/tile group level, such as in coding structures of CU/PB, or sequence header/picture header/SPS/APS/slice header/tile group header.

### 6. EMBODIMENTS

### 6.1 Abstract

In current G-PCC [1], layer-based QP offsets are signaled for RAHT coefficient coding. In this proposal, 3D quantization matrices for RAHT coding is proposed to signal a QP offset for each AC coefficient obtained by transforming the 2×2×2 residual after the up-sampled prediction.

### 6.2 Introduction

In current G-PCC [1], layer-based quantization is employed. During RAHT coding, the AC components of the residue 2×2×2 block generated after up-sampling prediction is transformed and quantized. We note that the DC is simply inherited and thus there is no residual DC component that needs to be sent to the decoder. While processing a 2×2×2 residue block, all the AC coefficients share the same quantizer.

### 6.3 Proposed Syntax

It may be beneficial, especially from the perceptual view, to have the flexibility of varying quantization for different AC components. Moreover, AC coefficients in different octree layers might have different physical meaning and significance. Thus, it may also be beneficial to further adapt to this by enabling different quantization for AC coefficients in different layers. To enable this, the proposal introduces some syntax elements that are presented next.

| | Descriptor |
|---|---|
| attribute_slice_header( ) { | |
| ash_attr_parameter_set_id | ue(v) |
| ash_attr_sps_attr_idx | ue(v) |
| ash_attr_geom_slice_id | ue(v) |
| ash_attr_layer_QP_present_flag | ue(v) |
| If( ash_attr_layer_QP_present_flag ) { | |
| num_layer = ( attribute_coding_type = = 1 ) ? raht_depth : | |
| num_detail_levels_minus1 + 1 | |
| for( idx = 0; idx < num_layer; idx++ ) { | |
| ash_attr_delta layer_QP_luma[idx] | se(v) |
| ash_attr_delta_layer_QP_chroma[idx] | se(v) |
| } | |
| } | |
| If(attribute_coding_type==1){ | |
| ash_attr_ACcomp_QP_luma_present_flag | u(1) |
| ash_attr_ACcomp_QP_chroma_present_flag | u(1) |
| If( ash_attr_ACcomp_QP_luma_present_flag ){ | |
| num_layer = raht_depth | |
| for( idx = 0; idx < num_layer; idx++ ) { | |
| ash_attr_ACcomp_ layer_QP_luma_present_flag[idx] | u(1) |
| if(ash_attr_ACcomp_layer_QP_luma_present_flag[idx]){ | |
| for (compidx=0; compidx<7;compidx++){ | |
| ash_attr_delta_ACcomp _layer_QP_luma[idx][compidx] | se(v) |
| } | |
| } | |
| If( ash_attr_ACcomp_QP_chroma_present_flag ){ | |
| num_layer = raht_depth | |
| for( idx = 0; idx < num_layer; idx++ ) { | |
| ash_attr_ACcomp_layer_QP_chroma_present_flag[idx] | u(1) |
| if(ash_attr_ACcomp_layer_QP_chroma_present_flag[idx]){ | |
| for (compidx=0; compidx<7;compidx++){ | |
| ash_attr_delta_ACcomp _layer_QP_chroma[idx][compidx] | se(v) |
| } | |
| } | |
| } | |

### 6.4 Semantics

ash_attr_ACcomp_QP_luma_present_flag: Indicates whether the delta QP for AC components are present for the luma channel
ash_attr_ACcomp_QP_chroma_present_flag: Indicates whether the delta QP for AC components are present for the chroma channel
ash_attr_ACcomp_layer_QP_luma_present_flag[idx]: Indicates whether the delta QP for AC components are present for the luma channel for a particular layer indexed by idx in octree
ash_attr_ACcomp_layer_QP_chroma_present_flag[idx]: Indicates whether the delta QP for AC components are present for the chroma channel for a particular layer indexed by idx in octree
ash_attr_delta_ACcomp_layer_QP_luma[idx][compidx]: Indicates the delta QP for AC component indexed by compidx for the luma channel for a particular layer indexed by idx in octree
ash_attr_delta_ACcomp_layer_QP_chroma[idx][compidx]: Indicates the delta QP for AC component indexed by compidx for the chroma channel for a particular layer indexed by idx in octree

### 6.5 Usage

The QP for each layer is first derived as per the current specification and is shown in FIG. 2. Upon deriving QP for a layer ‘1’, the QP for each AC coefficient indexed by ‘i’, is derived as

$${QP}_{l , i} = {QP}_{l} + Δ QP ( l , i ) ; i = 0 , 1 … 6$$

where, QP_{l,i} is the final QP used for a layer 1 and an AC component index i. ΔQP(l, i) is the delta value that is obtained from the syntax elements presented before.

### 7. REFERENCES

[1] MPEG 3DG and Requirements, “Call for Proposals for Point Cloud Compression V2”, ISO/IEC JTC1/SC29 WG11 N16763.
[2] ISO/IEC JTC 1/SC 29/WG 07, “Information technology—Coded Representation of Immersive Media—Part 5: Visual Volumetric Video-based Coding (V3C) and Video-based Point Cloud Compression (V-PCC)”, ISO/IEC 23090-5.
[3] ISO/IEC JTC 1/SC 29/WG 11, “Information technology—MPEG-I (Coded Representation of Immersive Media)—Part 9: Geometry-based Point Cloud Compression”, ISO/IEC 23090-9:2020(E).
[4] MPEG 3D Graphics Coding, “G-PCC codec description”, ISO/IEC JTC1/SC29 WG07 N0015.
[5] Ricardo L. De Queiroz and Philip A. Chou, “Compression of 3D Point Clouds Using a Region-Adaptive Hierarchical Transform”, IEEE Transactions on Image Processing.
[6] S. Lasserre, D. Flynn, “On an improvement of RAHT to exploit attribute correlation”, ISO/IEC JTC1/SC29/WG11 M47378.

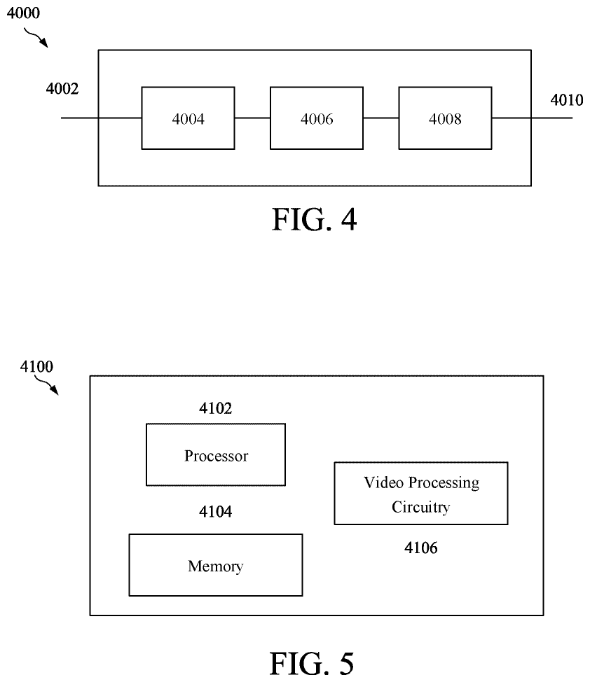

FIG. 4 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 5 is a block diagram of an example video processing apparatus 4100. The apparatus 4100 may be used to implement one or more of the methods described herein. The apparatus 4100 may be embodied in a smartphone, tablet, computer, Internet of Things (IOT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

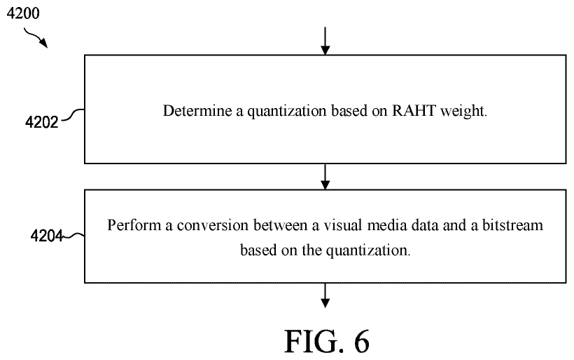

FIG. 6 is a flowchart for an example method 4200 of video processing. The method 4200 determines a quantization based on region-adaptive hierarchical transform (RAHT) weight at step 4202. A conversion is performed between a visual media data and a bitstream based on the quantization at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

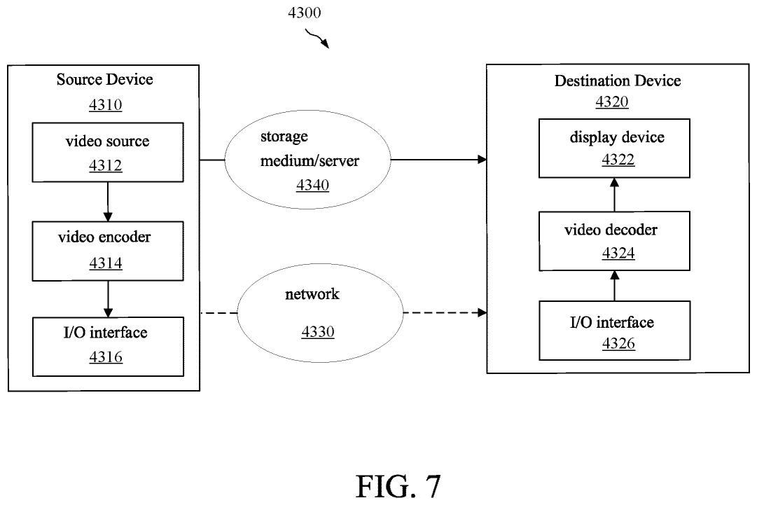

FIG. 7 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

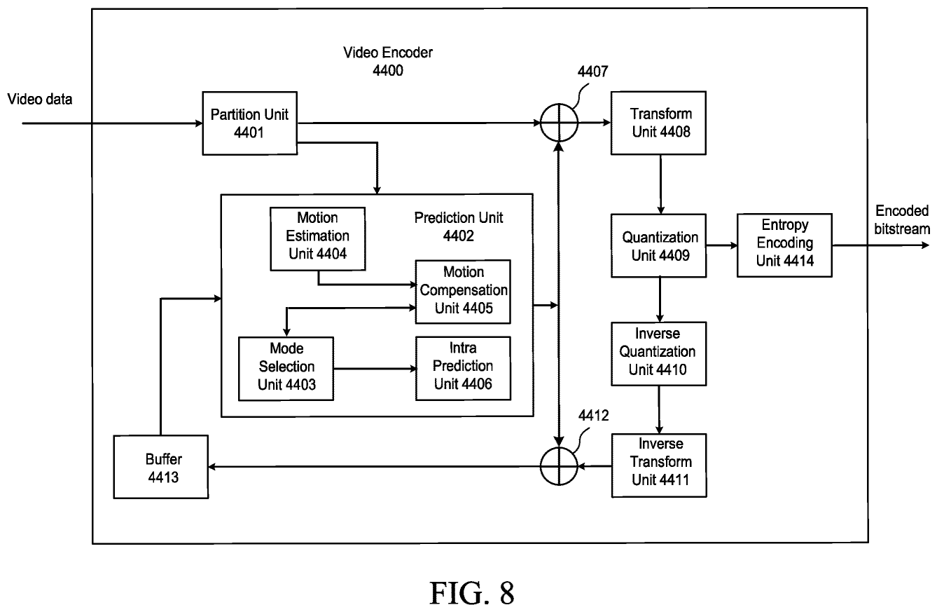

FIG. 8 is a block diagram illustrating an example of video encoder 4400, which may be video encoder 4314 in the system 4300 illustrated in FIG. 7. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

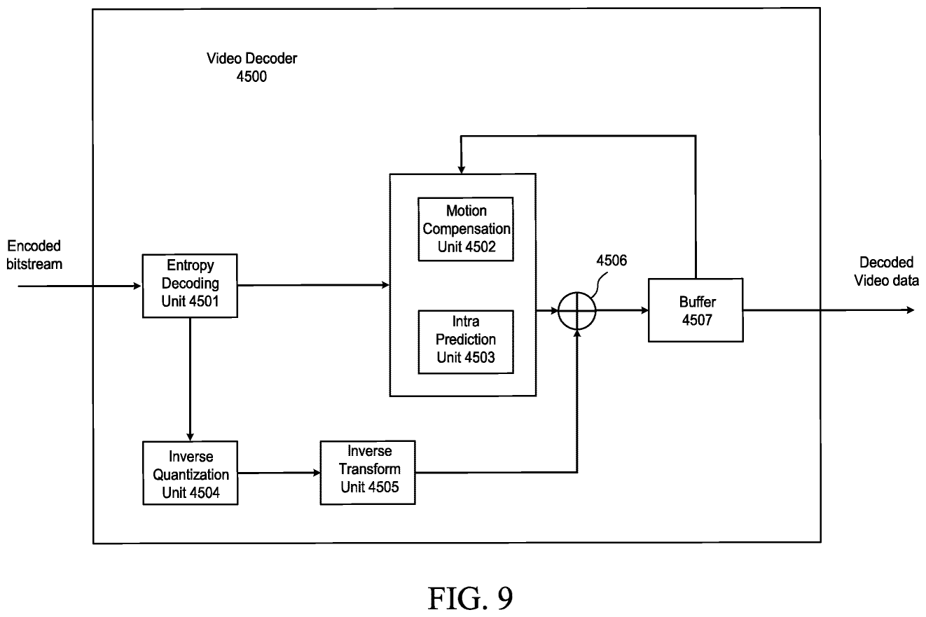

FIG. 9 is a block diagram illustrating an example of video decoder 4500 which may be video decoder 4324 in the system 4300 illustrated in FIG. 7. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

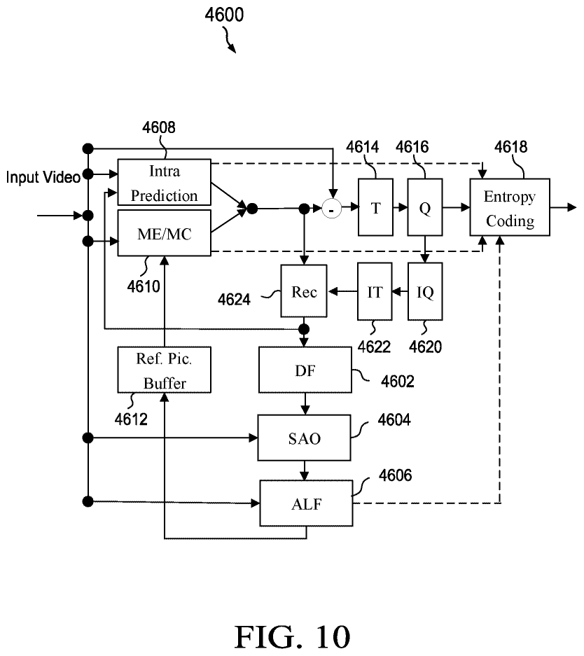

FIG. 10 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

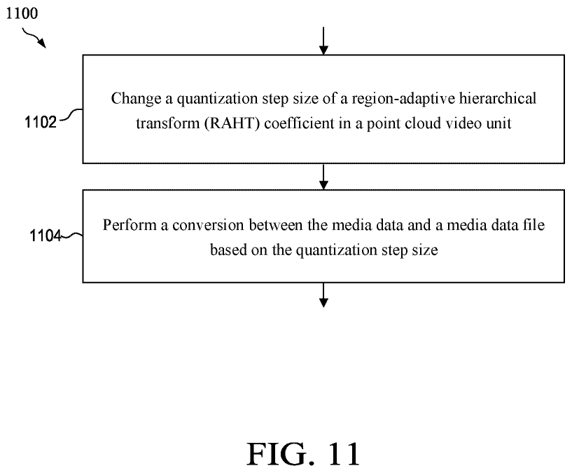

FIG. 11 is an image or video method implemented by a coding device (e.g., an encode or a decoder) according to an embodiment of the disclosure. In block 1102, the coding device changes a quantization step size of a region-adaptive hierarchical transform (RAHT) coefficient in a point cloud video unit. In block 1104, the coding device performs a conversion between the media data and a media data file based on the quantization step size.

A listing of solutions preferred by some examples is provided next.
1. A method for processing media data comprising: determining a quantization based on region-adaptive hierarchical transform (RAHT) weight; and performing a conversion between a visual media data and a bitstream based on the quantization.
2. The method of solution 1, wherein a quantization step size depends on a weight of a RAHT coefficient.
3. The method of any of solutions 1-2, wherein different quantization step sizes are used for RAHT coefficients of different weights, and wherein quantization step size usage is signaled via quantization parameter (QP) offsets.
4. The method of any of solutions 1-3, wherein weights are divided into different groups, and wherein different QP offsets are conveyed for different groups or subsets of groups.
5. The method of any of solutions 1-4, wherein quantization step size is determined based on a pre-defined function, and wherein the function comprises

$$Δ = \frac{K}{\sqrt{w}} ,$$

where A is the quantization step-size, K is a constant and w is the weight of the RAHT coefficient.
6. The method of any of solutions 1-5, wherein the step size is clamped between minimum and maximum step size values, wherein the value of K is signaled, wherein the function is used for only specific ranges or values of w, or combinations thereof.
7. The method of any of solutions 1-6, wherein a weight-based quantization is used instead of octree layer based adaptive quantization.
8. The method of any of solutions 1-7, wherein a weight-based quantization is a mode of quantization, and wherein additional information is signaled to indicate usage of a type of quantization.
9. The method of any of solutions 1-8, wherein quantization is determined based on both a layer of a RAHT coefficient and a weight of the RAHT coefficient.
10. The method of any of solutions 1-9, wherein a QP offset is determined based on a layer and is further modified based on a weight of a RAHT coefficient, or wherein a quantization step size varies based on a function that is jointly determined by a layer of a RAHT coefficient and a weight of the RAHT coefficient.
11. The method of any of solutions 1-10, wherein different quantization algorithms are applied for different attribute channels.
12. The method of any of solutions 1-11, wherein a luma quantization is based on a layer based adaptive quantization and a chroma quantization is based on a quantization dependent on a weight of a RAHT coefficient, or wherein different functions are employed for different attribute channels based on a weight of the RAHT coefficient, or wherein a division into different sub-groups is different for different channels and corresponding signaled offsets are different.
13. The method of any of solutions 1-12, wherein a quantization algorithm is selectively enabled for a group of voxels.
14. The method of any of solutions 1-13, wherein different quantization is used for different transform coefficients for a 2×2×2 transformed residue block after up-sampled prediction.
15. The method of any of solutions 1-14, wherein a 2×2×2 QP offset matrix is used to derive the quantization step size, and wherein the 2×2×2 QP offset matrix is specified at a sequence level, a picture level, a slice level, or a tile level.
16. The method of any of solutions 1-15, wherein a 2×2×2 QP offset matrix depends on the octree layer, and wherein usage of the 2×2×2 QP offset matrix is restricted to specified layers in an octree or different three dimensional (3D) QP offset matrices are used for different layers in the octree.
17. The method of any of solutions 1-16, wherein a 2×2×2 QP offset matrix depends on RAHT weight, and wherein usage of the 2×2×2 QP offset matrix is restricted to specified sub-bands of RAHT where a sub-band represents a group of coefficients that have a same RAHT weight or different 3D QP matrices are used for different sub-bands.
18. The method of any of solutions 1-17, wherein a 2×2×2 QP offset matrix depends on an attribute channel, and wherein the 2×2×2 QP offset matrix is used for only a subset of attribute channels or different QP offset matrices are used for different attribute channels.
19. The method of any of solutions 1-18, wherein a 2×2×2 QP offset matrix depends on picture region, and wherein the 2×2×2 QP offset matrix is used for only some regions or different QP offset matrices are used for different regions.
20. The method of any of solutions 1-19, wherein only a subset of coefficients are modified, and wherein a coarser quantization is applied for high frequency coefficients without modifying low frequency coefficients or usage of partial modification of coefficients depends on attribute channel, RAHT weight, or octree layer.
21. The method of any of solutions 1-20, wherein usage of a 2×2×2 QP offset matrix or a partial matrix depends on octree layer or attribute channel.
22. The method of any of solutions 1-21, wherein using different quantization for different transform coefficients is selectively disabled for a group of voxels.
23. The method of any of solutions 1-22, wherein usage of quantization based on RAHT weight is signaled in a sequence parameter set (SPS), a geometry parameter set (GPS), or an adaptation parameter set (APS).
24. The method of any of solutions 1-23, wherein usage of quantization based on RAHT weight is signaled for a video unit, and wherein the video unit is a tile, a slice, or a slice header.
25. The method of any of solutions 1-24, wherein QP offsets are signaled for different sub-bands, a QP offset is progressively coded, flags are signaled to enable adaptive quantization for different sub-bands, flags are signaled based on the attribute channels, layers, regions, tiles, or groups of voxels to enable the adaptive quantization, flags are signaled to specify adaptive an quantization function for different frames, sequences, slices, tiles, attribute channels, or regions based on a list or table of different functions based on RAHT weight, or combinations thereof.
26. The method of any of solutions 1-25, wherein a QP matrix or a matrix of QP offsets is signaled for different RAHT coefficients, QP offsets are progressively coded, a partial QP matrix is signaled, flags specify usage of a full matrix or partial matrix and flags depend on octree layer or regions, flags are signaled to signal a subset of 2×2×2 coefficients for which a QP offset is applied, or combinations thereof.
27. An apparatus for processing video data comprising: a processor; and a non-transitory memory with instructions thereon, wherein the instructions upon execution by the processor, cause the processor to perform the method of any of solutions 1-26.
28. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-26.
29. A non-transitory computer-readable recording medium storing a bitstream of a video which is generated by a method performed by a video processing apparatus, wherein the method comprises: determining a quantization based on region-adaptive hierarchical transform (RAHT) weight; and generating a bitstream based on the determining.
30. A method for storing bitstream of a video comprising: determining a quantization based on region-adaptive hierarchical transform (RAHT) weight; generating a bitstream based on the determining; and storing the bitstream in a non-transitory computer-readable recording medium.
31. A method, apparatus or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing visual media data, comprising:
performing a conversion between visual media data and a bitstream of the visual media data based on region-adaptive hierarchical transform (RAHT) coefficient coding,
wherein a quantization parameter (QP) offset matrix is used in the RAHT coefficient coding to derive a QP offset for each alternating current (AC) coefficient for at least one attribute component in a RAHT tree.

2. The method of claim 1, wherein the QP offset matrix is a 2×2×2 QP offset matrix.

3. The method of claim 1, wherein the QP offset matrix is used to derive a quantization step size used in the RAHT coefficient coding.

4. The method of claim 1, wherein the QP offset matrix is specified at a sequence level, a slice level, or a tile level of the bitstream.

5. The method of claim 1, wherein the QP offset matrix is based on octree coding.

6. The method of claim 1, wherein the QP offset matrix is specified to be used for certain layers in the RAHT tree.

7. The method of claim 1, wherein different QP offset matrices are used for different layers in the RAHT tree.

8. The method of claim 1, wherein the QP offset matrix is based on an index identified for the attribute component.

9. The method of claim 1, wherein the QP offset matrix is used for a subset of attribute components.

10. The method of claim 1, wherein the QP offset matrix is used for attribute components identified with different indices.

11. The method of claim 1, wherein the conversion includes encoding the visual media data into the bitstream.

12. The method of claim 1, wherein the conversion includes decoding the visual media data from the bitstream.

13. An apparatus for processing visual media data comprising: a processor and a non-transitory memory with instructions thereon, wherein the instructions upon execution by the processor, cause the processor to:
perform a conversion between visual media data and a bitstream of the visual media data based on region-adaptive hierarchical transform (RAHT) coefficient coding,
wherein a quantization parameter (QP) offset matrix is used in the RAHT coefficient coding to derive a QP offset for each alternating current (AC) coefficient for at least one attribute component in a RAHT tree.

14. The apparatus of claim 13, wherein the QP offset matrix is a 2×2×2 QP offset matrix.

15. The apparatus of claim 13, wherein the QP offset matrix is based on octree coding.

16. The apparatus of claim 13, wherein the QP offset matrix is specified to be used for certain layers in the RAHT tree.

17. The apparatus of claim 13, wherein different QP offset matrices are used for different layers in the RAHT tree.

18. The apparatus of claim 13, wherein the QP offset matrix is based on an index identified for the attribute component.

19. A non-transitory computer-readable storage medium storing instructions that cause a processor to:
perform a conversion between visual media data and a bitstream of the visual media data based on region-adaptive hierarchical transform (RAHT) coefficient coding,
wherein a quantization parameter (QP) offset matrix is used in the RAHT coefficient coding to derive a QP offset for each alternating current (AC) coefficient for at least one attribute component in a RAHT tree.

20. A non-transitory computer-readable recording medium storing a bitstream of visual media data which is generated by a method performed by a visual media data processing apparatus, wherein the method comprises:
generating the bitstream based on region-adaptive hierarchical transform (RAHT) coefficient coding,
wherein a quantization parameter (QP) offset matrix is used in the RAHT coefficient coding to derive a QP offset for each alternating current (AC) coefficient for at least one attribute component in a RAHT tree.
